(19) United States
(12) Patent Application Publication
(10) Pub. No.: US 2019/0249120 A1
(43) Pub. Date: Aug. 15, 2019

(54) CATALYST COMPOSITION

(71) Applicant: ITACONIX (U.K.) LIMITED, Deeside (GB)

(72) Inventors: Madeleine Eleanor ANDERSON, Deeside (GB); Paul Hugh FINDLAY, Deeside (GB); David Alan PEARS, Deeside (GB); Evan Alun ROBERTS, Deeside (GB); Lisa Elizabeth SCULLION, Deeside (GB)

(73) Assignee: Itaconix, Zone 2 (U.K.) Limited, Deeside (GB)

(21) Appl. No.: 16/318,002

(22) PCT Filed: Jul. 14, 2017
(86) PCT No.: PCT/GB2017/052081

§ 371 Date: Jan. 15, 2019

(30) Foreign Application Priority Data
Jul. 15, 2016 (GB) 1612357.2

(51) Int. Cl. C11D 3/39; C11D 3/37; C11D 3/12; C11D 3/22

(52) U.S. Cl. CPC C11D 3/3932; C11D 3/222; C11D 3/1246; C11D 3/3753

(57) ABSTRACT

Catalyst compositions are disclosed, as well as their methods of manufacture and their uses in detergent formulations, such as powdered laundry and dishwash formulations. The catalyst composition may be readily incorporated into powder and/or solid detergent formulations, wherein they exhibit remarkable stability properties and may enhance the bleaching action and thus cleaning capabilities of the detergent formulation.

### FIELD OF INVENTION

The present invention relates to a catalyst composition. Suitably, the present invention relates catalyst composition made up of particles that comprise a bleach-activating catalyst. The present invention further relates to methods of preparing these catalyst compositions (e.g. by aqueous granulation, compression, extrusion or spheronisation techniques) and to the use of these compositions as components of detergent formulations for applications such as, for example, machine dishwashing or machine laundry washing. The present invention also relates to: (i) detergent formulations (e.g. laundry or dishwashing detergent formulations) comprising these particles, a bleaching agent and optionally a bleach activator; (ii) methods of making these detergent formulations; and (iii) the use of these detergent formulations for applications such as, for example, machine dishwashing or machine laundry washing.

### BACKGROUND TO THE INVENTION

It is known in the art that the incorporation of bleaching agents into dishwashing formulations aids the cleaning of dishware and associated utensils, drinking vessels and kitchenware in automatic dishwashing. In the case of solid dishwashing powders or tablets, these bleaching agents are typically present as solid persalts, particularly percarbonate salts, such as sodium percarbonate (SPC). These bleaching agents act by bleaching, and thereby decolourising, stains present on the dishware. The bleaching action also acts as a de-odouriser and has an anti-microbiological action on the dishware. The typical wash temperature of an automatic dishwasher (ADW) is around 60° C. and it is usual for the bleaching agent to be present in combination with a bleach activator, such as tetraacetyl ethylene diamine (TAED) or other such bleach activators. The bleach activator (e.g. TAED) can give rise to an active bleaching agent, e.g. a peracetic acid in the case of SPC, and this active bleaching agent provides a bleaching action at a lower temperature than that obtainable by using the persalt alone.

Bleach-activating catalysts, particularly those based on transition metal salts such as manganese, can accelerate the activation of the bleach compound. Common manganese catalysts that are used as bleach-activating catalysts include manganese (II) oxalate or manganese bis(N,N′, N″-trimethyl-1,4,7-triazacyclononane)-trioxo-dimanganese (IV) di(hexafluorophosphate) (Mn Me-TACN). Originally Mn Me-TACN was developed and used in laundry detergent formulations, but this use has reduced significantly because of damage caused to the garments. Catalysts of this type are now prevalent in ADW applications where they show enhanced bleaching performance in combination with the bleaching agent, and optionally in the presence of a bleach activator. The use of catalysts in these compositions can be particularly useful when bleaching troublesome stains, such as tea, at low temperatures.

The bleach catalysts are typically incorporated into ADW formulations at levels of from 0.01 to 1% weight/weight of the ADW formulation. Furthermore, as these catalysts tend to be dusty and costly, they are typically pre-formed into particles for ease of dosing and manufacturing of the ADW product formulation. The catalysts are also reactive and can be denatured by contact with various formulation components such as strong chelating agents and alkali media, as such the formation of granules can alleviate this issue by isolating the catalysts from the rest of the formulation. Since the catalysts are used at low amounts compared to the rest of the formulation, it can be challenging to obtain a uniform distribution of the catalyst within the ADW formulation Furthermore, the stability or useful shelf life of the resultant formulation can also be a major issue. This is particularly true for compressed tablet formulations where the catalyst or catalyst-containing particle is typically added and then compressed into a discrete section or layer in the tablet and where the formulation (e.g. a powder or granular ADW formulation) can be exposed to high temperatures and/or humidities during storage.

Granules can also be prepared that comprise a bleach-activating catalyst and a bleach activator, such as TAED. It is claimed that the close proximity of the bleach catalyst and bleach activator can lead to increased bleaching performance during use. However, this can also lead to a reduction in the stability of the catalyst and can give rise to dissolution and release issues.

There is therefore a need for improved compositions or formulations comprising bleach-activating catalysts.

The present invention was devised with the foregoing in mind.

### SUMMARY OF THE INVENTION

The inventors have surprisingly found that the use of a water soluble polymer can lead to the formation of highly stable particles comprising a bleach-activating catalyst.

Thus, in one aspect, the present invention provides a catalyst composition comprising a plurality of particles, wherein said particles comprise:
0.1-8 wt. % of a bleach-activating catalyst;
0.1-20 wt. % of a water-soluble polymer;
5-55 wt. % of an absorbent;
5-85 wt. % of a filler; and
0-40 wt. % of a water-soluble salt;

with the proviso that the particles do not comprise more than 10 wt. % of a bleach activator.

In another aspect, the present invention provides a catalyst composition comprising a plurality of particles, wherein said particles comprise:
0.1-8 wt. % of a bleach-activating catalyst;
0.1-20 wt. % of a water-soluble polymer;
5-55 wt. % of an absorbent;
5-85 wt. % of a filler; and
0-40 wt. % of a water-soluble salt;

with the proviso that the particles do not comprise a bleach activator.

In yet another aspect, the present invention provides a process for making a catalyst composition as defined herein, the process comprising: (i) mixing the bleach-activating catalyst, water-soluble polymer, absorbent, filler, and water-soluble salt, typically in the presence of some water; (ii) forming particles thereof; and (iii) drying the particles.

In another aspect, the present invention provides a catalyst composition prepared by any one of the methods described herein.

In a further aspect, the present invention provides a detergent formulation (e.g. a dishwasher or laundry washing formulation) comprising a bleaching agent, optionally a bleach activator, and a catalyst composition as defined herein.

In yet another aspect, the present invention provides a process for forming a detergent formulation as defined herein, the process comprising mixing the particle composition of the present invention with a formulation comprising a bleaching agent and optionally a bleach activator.

In yet another aspect, the present invention provides a detergent formulation prepared by any one of the methods defined herein.

### DETAILED DESCRIPTION OF THE INVENTION

The Catalyst Compositions of the Present Invention

As indicated above, the present invention provides a catalyst composition comprising a plurality of particles, wherein said particles comprise:
0.1-8 wt. % of a bleach-activating catalyst;
0.1-20 wt. % of a water-soluble polymer;
5-55 wt. % of an absorbent;
5-85 wt. % of a filler; and
0-40 wt. % of a water-soluble salt;

with the proviso that the catalyst composition does not comprise more than 10 wt. % of a bleach activator.

The particles of the present invention may be incorporated into existing formulations comprising a bleaching agent and optionally a bleach activating agent to form a detergent formulation of the present invention.

The inventors have surprisingly found that the use of a water-soluble polymer in the catalyst compositions of the present invention results in bleach-activating catalyst compositions that have increased stability when compared to the catalyst alone (see the example section herein).

The water soluble polymer may be present within the particles and/or present as a coating on the particle surface. Suitably, the water soluble polymer is present within the particles (e.g. acting as a binder in a matrix particle).

In an embodiment, the water-soluble polymer can be incorporated into the particles by coating bleach-activating catalyst-containing particles, such as, for example, an extrudate, a spheroid (e.g. formed by wet extrusion), a spray agglomerated or spray granulated particle, or a granule formed via high shear granulation or a compaction or compression process. The presence of the water-soluble polymer assists in the formation of the particle. Furthermore, when the particles are incorporated into a detergent formulation as defined herein, the water-soluble polymer coating aids the isolation of the catalyst from the reactive components within the formulation.

In an alternative embodiment, the water-soluble polymer can be included within the particles when they are formed. In such embodiments, the water-soluble polymer is mixed with the bleach-activating catalyst, the absorbent, the filler and the water-soluble salt and formed into particles by conventional techniques well known in the art. The fillers and absorbent are suitably inert organic or inorganic materials, which can further enhance the stability of the bleach-activating catalyst.

The catalyst composition is suitably a solid composition, for example a granular solid composition, that can be used in the formulation of the detergent formulations defined herein.

The catalyst compositions of the present invention do not comprise large quantities of a bleach activating agent present within the particles. In an embodiment, the catalyst composition does not comprise more than 5 wt. % of a bleach activator. Suitably, the catalyst composition does not comprise more than 2 wt. % of a bleach activator. More suitably, the catalyst composition does not comprise more than 1 wt. % of a bleach activator. Most suitably, the catalyst composition does not comprise a bleach activator. As indicated above, the inclusion of large quantities of a bleach activating agent can lead to a reduction in the stability of the catalyst and can give rise to dissolution and release issues.

In an embodiment, the catalyst composition consists essentially of a bleach-activating catalyst, a water-soluble polymer, an absorbent, a filler, and a water-soluble salt. In such embodiments, one or more additional components may be present in the catalyst composition in addition to these recited components, but any additional components suitably comprise less than 10 wt. %, or less than 8% wt. %, or less than 6 wt. %, or less than 5 wt. %, or less than 4 wt. %, or less than 3 wt. %, or less than 2 wt. % or less than 1 wt. %, of the catalyst composition.

Suitably, the catalyst composition consists of a bleach-activating catalyst, a water-soluble polymer, an absorbent, a filler, and a water-soluble salt.

In an embodiment, the catalyst composition is uncoated. In such embodiments, the particles or granules of the catalyst composition have not undergone a dedicated coated step during their manufacture, such that they do not contain a discrete coating layer.

The Bleach-Activating Catalyst

Any suitable bleach-activating catalyst may be used in the catalyst compositions of the present invention.

Typically, the bleach catalyst is selected from transition metal-based salts or complexes, particularly salts or complexes comprising iron, cobalt, manganese, vanadium, ruthenium, titanium, copper or molybdenum in the 2+, 3+ or 4+ oxidation state. The counter-ions present in the salts or complexes are typically selected from the group consisting of: halides, such as chlorides; oxides; oxalates; acetates; nitrate; sulfate; sulfonate; acetate; trifluoro sulfonate; chlorate; hexafluoro phosphonate; and nitrogen- oxygen- or phosphorus-based chelating agents, such as, for example, linear or straight chain polyamines such as N, N, N′, N′-tetraethylene diamine (ED) and higher homologues with ethylene or propylene bridges between the tertiary amine units, or acidic chelating agents such as, for example, ethylene diamine tetra acetic acid (EDTA).

Complexes of these transition metals with cyclic amine chelating units are especially effective. Particular examples of such complexes include: N,N′, N″-trimethyl-1,4,7-triazacyclononane (Me-TACN), 1,4,7-triazacyclononane (TACN) or derivatives of cyclam or cyclen (such as 1,8-dimethylcyclam, 1,7-dimethyl cyclam, 1,8-diethylcyclam, 1,7-diethylcyclam, 1,8-dibenzylcylam and 1,7-dibenzylcyclam)—containing complexes of high state transition metals such as Mn(IV), in particular the complex bis(N,N′, N″-trimethyl-1,4,7-triazacyclononane)-trioxo-dimanganese (IV) where the counterion can be chosen from those specified above (e.g. simple halides (e.g. chloride) or the more water soluble hexafluoro phosphine (PF₆) species).

Bridging ligated catalyst species, such as 1,5,9-trimethyl-1,5,9-triazacyclododecane (Me-TACD), may also be used where two cyclic nitrogenous ligands are bridged via a saturated alkyl unit through the tertiary amine units and complexed with a di-metal centre, for example a Mn(IV) and/or a Mn(III) unit where the two metal centres are bridged by two oxide and one acetate ion. The formed complex has a net divalent positive charge which is balanced by a negatively charged counterion or ions optionally selected from the group consisting of: halides, e.g. chloride; nitrate; sulfate; sulfonate; acetate; trifluoro sulfonate; chlorate; or hexafluoro phosphonate.

In an embodiment, the catalyst is [Mn^{Iv}₂ (μ-O)₃ (Me-TACN)₂ (PF₆)₂ and/or [Mn^{IV}Mn^{III} (μ-O)₂ (μ-OAc) (Me₄4-DTNE)] (PF₆)₂.

In an embodiment, the catalyst composition comprises 0.1 to 8 wt. % of the bleach-activating catalyst. Suitably, the catalyst composition comprises 0.5 to 7 wt. % of the bleach-activating catalyst. More suitably, the catalyst composition comprises 0.5 to 6 wt. % of the bleach-activating catalyst. Even more suitably, the catalyst composition comprises 0.5 to 5 wt. % of the bleach-activating catalyst. Yet more suitably, the catalyst composition comprises 0.5 to 4 wt. % of the bleach-activating catalyst. Still more suitably, the catalyst composition comprises 1.5 to 3 wt. % of the bleach-activating catalyst. Most suitably, the catalyst composition comprises 1.5 to 2.5 wt. % of the bleach-activating catalyst.

Thus, it will be understood that the bleach-activating catalyst is present in an amount of 0.1 to 8 wt. % of the catalyst composition. In an embodiment, 0.5 to 7 wt. % of the bleach-activating catalyst is present in the catalyst composition defined herein. In another embodiment, 0.5 to 6 wt. % of the bleach-activating catalyst is present in the catalyst composition defined herein. In another embodiment, 0.5 to 5 wt. % of the bleach-activating catalyst is present in the catalyst composition defined herein. In another embodiment, 0.5 to 4 wt. % of the bleach-activating catalyst is present in the catalyst composition defined herein. In another embodiment, 1 to 3 wt. % of the bleach-activating catalyst is present in the catalyst composition defined herein. In an embodiment, 1.5 to 2.5 wt. % of the bleach-activating catalyst is present in the catalyst composition defined herein.

In another embodiment, the bleach-activating catalyst of the catalyst composition has a density at 25° C. of 0.40-1.5 gcm⁻³. Suitably, the bleach-activating catalyst of the catalyst composition has a density at 25° C. of 0.60-1.5 gcm⁻³ More suitably, the bleach-activating catalyst of the catalyst composition has a density at 25° C. of 0.40-1.0 gcm⁻³ Most suitably, the bleach-activating catalyst of the catalyst composition has a density at 25° C. of 0.60-1.0 gcm⁻³.

Water-Soluble Polymer

The water-soluble polymer suitably has a solubility of at least 200 g/L water at 25° C. This encompasses polymers that are entirely water-soluble as well as those that are substantially water-soluble. It will be appreciated that the solubility of substantially water-soluble polymers may be increased by changes in temperature, pH, or an increase in dilution factor.

The water-soluble polymer may be a linear, branched or cross-linked homopolymer or copolymer, or a mixture thereof. Suitable polymers include one or more of poly(vinylpyrrolidone), functionalised poly(vinyl alcohol)s, and linear, branched or cross-linked polymers or copolymers prepared from one or more of the following monomers: N-vinylpyrollidone, (meth)acrylic acid, acrylic acid, maleic acid, fumaric acid, itaconic acid, 2-acrylamido-2-methyl-1-propanesulfonic acid, vinyl alcohol, vinyl acetate, poly (vinyl alcohol)s, (such as Mowiol® from Kuraray), functionalised poly (vinyl alcohol)s (including, for example, butyl acetals), polymers such as Kolloidon® or Luvicross® available from BASF, acrylic copolymers such as Arbopol® (homo- and copolymers of acrylic acid cross-linked with a polyalkenyl polyether) or Ultralez 10, 21, 30 or Noveon®AA-1 range from Lubrizol (acrylic acid polymer cross-linked with divinyl glycol), and the Sokalan® range from BASF (PAA) such as CP5, CP10 and PA30.

In an embodiment, the water-soluble polymer is poly(vinyl alcohol) (PVOH) or a poly(vinyl alcohol)-based polymer.

PVOH polymers are typically manufactured by the polymerisation of vinyl acetate to obtain poly(vinyl acetate) (PVAc). Thereafter the PVAc is hydrolysed to poly(vinyl alcohol), as shown in Scheme 1 below:

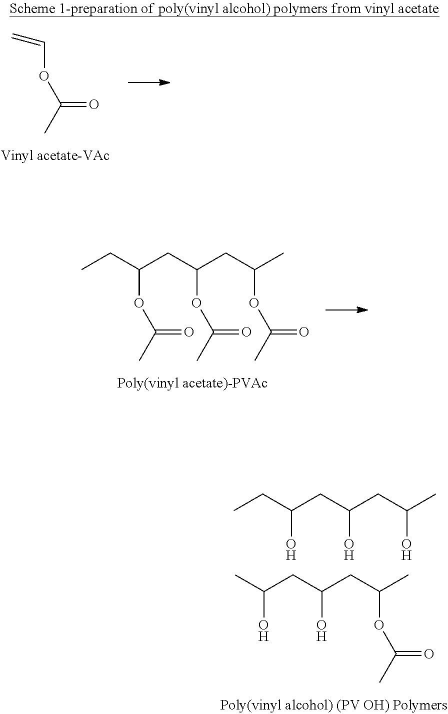

It will be appreciated that during hydrolysis of the PVAc, a number of the vinyl acetate groups present may remain un-hydrolysed in the resulting PVOH polymer. Such polymers, with a mixture of vinyl alcohol units and un-reacted vinyl acetate units, are commonly referred to by the name PVOH by those skilled in the art. The degree of hydrolysis of the PVOH is important in determining its properties.

Optionally, a second olefinic monomer, such as ethylene or propylene, may be copolymerised with the vinyl acetate and the resulting copolymers hydrolysed to create vinyl alcohol groups in the same manner. The olefinic monomer may be present in an amount from 1 to 50 mol % or 2 to 40 mol % or 5 to 20 mol % of the polymer backbone. The resulting poly(vinyl alcohol) polymers typically have modified water solubility and other physical properties compared with those derived from homopolymers of vinyl acetate. Alternatively, the olefinic monomer may be a vinylic, acrylic or methacrylic monomer, including styrene, acrylonitrile, methacrylonitrile, crotononitrile, vinyl halides, vinylidene halides, (meth)acrylamide, N,N-dimethyl acrylamide, vinyl polyethers of ethylene or propylene oxide, vinyl esters such as vinyl formate, vinyl benzoate or vinyl ethers (such as VeoVₐ™ 10 available from Momentive™), vinyl ethers of heterocyclic vinyl compounds, alkyl esters of mono-olefinically unsaturated dicarboxylic acids and in particular esters of acrylic and methacrylic acid; vinyl monomers with hydroxyl functionality 2-hydroxy ethyl (meth)acrylate, 2-hydroxy propyl (meth)acrylate, glycerol mono(meth)acrylate, 4-hydroxy butyl (meth)acrylate, hydroxyl stearyl methacrylate, N-methylol (meth)acrylamide; vinyl monomers with additional functionality for cross-linking or adhesion promotion or post functionalization of the vinyl polymers, such as diacetone acrylamide, aceto acetoxy ethyl (meth)acrylate, glycidyl methacrylate, 2-acrylamido-2-methylpropane sulfonic acid, (meth)acrylic acid, beta carboxy ethyl (meth)acrylate, maleic anhydride, styrene sulfonic acid, sodium sulfo propyl methacrylate, itaconic acid; N, N′-dimethyl acrylamine, N-isopropyl acrylamide, N,N-dimethyl ethyl amino (meth)acrylate, N,N-diethyl ethyl amino (meth)acrylate, N,N-dimethyl propyl amino (meth)acrylate, N,N-diethyl propyl amino (meth)acrylate, 4—and 2-vinyl pyridine, amino methyl styrene, crotonic acid, esters of crotonic acid, crotononitrile, vinyl imidazole; and basic amine monomers can be polymerised as the free amine, protonated salts or as a quaternised amine salt. Where a monomer is indicated with a prefix in brackets (e.g. meth) it shall be understood that it be used in a form with or without the methyl substitution, or alternatively an alternative alkyl group may be present. For example, in the case of acrylic acid, methacrylic acid or another derivative such as ethacrylic acid may be used.

In addition it may be envisioned that a PVOH based polymer may conceivably contain ‘PVOH’ as a block within another polymer or copolymer or as grafts to, or from, another polymer or copolymer backbone or as a branched polymer containing short, oligomeric or polymeric cross-links within the polymeric or co-polymeric structure as a whole. A degree of cross linking may be beneficial in order to maintain structural integrity of the coated layer as well as to increase the barrier properties of the layer. Cross-linking may be carried out by any suitable technique which are well known and may include the use of agents such as epoxides, formaldehyes, isocyanates, reactive siloxanes, anhydrides, amidoamines, boric acid and suitably reactive transition metals and derivatives thereof.

It will be appreciated that PVOH may also be prepared by the hydrolysis of other poly(vinyl esters) such as poly(vinyl formate), poly(vinyl benzoate) or poly(vinyl ethers). Similarly a copolymer of vinyl alcohol such as poly(ethylene-vinyl alcohol) may also be prepared by copolymerising the relevant monomer with a vinyl ester other than vinyl alcohol and hydrolysing the resulting polymer for instance. Such polymers are also within the scope of the present invention.

PVOH grades with varying degrees of polymerization and hydrolysis are available under the trade name Poval® (Kuraray Chemicals) and include partly and fully saponified grades. Specific examples of fully saponified Poval® (previously called the Mowiol range) include those known as 3-85, 4-88, 4-98, 6-98, 8-88, 10-98, 13-88, 15-99, 20-98 and 30-98 (CAS Nos: 9002-89-5). Specific examples of partly saponified Poval® include those known as 3-85 G4, 4-88 G2, 8-88 G2, 18-88 G2, 23-88 G2, 47-88 G2, 3-85, 4-88, 5-88, 8-88, 13-88, 18-88, 23-88, 26-88, 32-88, 40-88, 44-88, 47-88, 30-92, 4-88 LA, 8-88 LA and 40-88 LA (CAS Nos: 23213-24-5). The first number in the nomenclature denotes the viscosity of the 4% aqueous solution at 20° C. as a relative measure for the molar mass of the Mowiol; the second number denotes the degree of hydrolysis of the polyvinyl acetate from which the Mowiol grade is derived. Poval® 3-85, 4-88, 4-98 and 10-98 are particularly preferred.

In an embodiment, the water-soluble polymer is a PVOH or PVOH-based polymer having degree of hydrolysis within the range 60-99%. Suitably, the water-soluble polymer is a PVOH or PVOH-based polymer having degree of hydrolysis within the range 80-99%. Such high degree of hydrolysis gives rise to favourable solubility characteristics.

In another embodiment, the water-soluble polymer is a PVOH or PVOH-based polymer having a molecular weight in the range of 1,000 to 300,000 Da or, more typically, 20,000 to 100,000 Da. Aqueous solutions of such polymers having improved handling characteristics.

In a particular embodiment, the water-soluble polymer is a poly(vinyl alcohol)-based polymer in which a portion of the hydroxyl groups have been modified by reaction with a (2-22C) aldehyde. The use of such water-soluble polymers may considerably improve the processing of the catalyst composition with respect to the unmodified PVOH-based polymer. Suitably, the water-soluble polymer is a poly(vinyl alcohol)-based polymer in which a portion of the hydroxyl groups have been modified by reaction with a (2-10C)aldehyde. The degree of modification of the PVOH based polymer may be from about 0.1% to about 50%, by this it is meant that the ‘OH’ portion of the PVOH has been replaced by the given percentage. The person skilled in the art will appreciate that, for example, in the case of the reaction of an aldehyde with TVOH' for each molar quantity of aldehyde two molar quantities of ‘OH’ are substituted via the acetalation reaction. Hence a 50% modified PVOH will have been reacted with 25% of a suitable aldehyde, and, of course the degree of hydrolysis of the PVOH will dictate the maximum level of substitution possible.

In another embodiment, the modified water-soluble polymer is a PVOH based polymer in which at least a portion of the H atoms of the —OH groups have been exchanged for 2-10C aldehyde groups (i.e. by an ester linkage). Suitably, between 0.1 and 50% of the —OH groups have been exchanged for 2-10C aldehyde groups. More suitably, between 1 and 15% of the —OH groups have been exchanged for 2-10C aldehyde groups. Even more suitably, between 2 and 12% of the —OH groups have been exchanged for 2-10C aldehyde groups.

In another embodiment, the modified water-soluble polymer has a structure that can be schematically represented by formula (I) shown below:

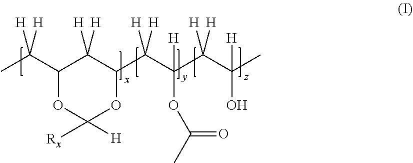

wherein each Rₓ is (1-9C)alkyl, (2-9C)alkenyl or (2-9C)alkynyl,
   x denotes the proportion of modified PVOH monomeric moieties,
   y denotes the proportion of residual acetate monomeric moieties present in the polymer following hydrolysis to yield the PVOH, and
   z denotes the proportion of unmodified PVOH monomeric moieties.

It will also be understood that formula (I) shows a schematic representation illustrating the structures of the various monomeric moieties that collectively constitute the modified PVOH. Hence, formula (I) does not necessarily imply that the water-soluble polymers are block copolymers or alternating copolymers. On the contrary, monomeric moieties x, y and z may be randomly distributed throughout polymers falling within the scope of formula (II). It will also be understood that PVOH-based polymers falling within the scope of formula (II) may comprise, in addition to monomeric moieties x, y and z, other monomeric moieties.

In another embodiment, the water-soluble polymer is the product formed by reacting a PVOH-based polymer with a 2-10C aldehyde, such that between 0.1 and 50% of the —OH groups are exchanged for 2-10C aldehyde groups. Suitably, the water-soluble polymer is the product formed by reacting a PVOH-based polymer with a 2-10C aldehyde, such that between 1 and 15% of the —OH groups are exchanged for 2-10C aldehyde groups. More suitably, the water-soluble polymer is the product formed by reacting a PVOH-based polymer with a 2-10C aldehyde, such that between 2 and 12% of the —OH groups are exchanged for 2-10C aldehyde groups. Even more suitably, the water-soluble polymer is the product formed by reacting a PVOH-based polymer with a 2-10C aldehyde, such that between 2 and 10% of the —OH groups are exchanged for 2-10C aldehyde groups. Most suitably, the water-soluble polymer is the product formed by reacting a PVOH-based polymer with a 2-10C aldehyde, such that between 4 and 9% of the —OH groups are exchanged for 2-10C aldehyde groups.

In a particularly suitable embodiment, the water-soluble polymer is a PVOH polymer in which a portion of the available —OH groups have been modified by reaction with butyraldehyde. Such polymers have a structure according to formula (I) wherein Rₓ is butyl.

Suitably, the degree of substitution of the OH groups for such polymers is from 0.1 to 50%. More suitably, the degree of substitution of the OH groups for such polymers is from 1 to 20%. Most suitably, the degree of substitution of the OH groups for such polymers is from 2 to 10%

In an exemplary embodiment, the water-soluble polymer is a PVOH polymer having a degree of hydrolysis of 80-99% that has modified by reaction of 5% or 8% of the available OH groups with butyraldehyde.

In an embodiment, the catalyst composition comprises 0.1-20 wt. % of the water-soluble polymer. Suitably, the catalyst composition comprises 0.5-15 wt. % of the water-soluble polymer. More suitably, the catalyst composition comprises 0.5-10 wt. % of the water-soluble polymer. Even more suitably, the catalyst composition comprises 0.5-8 wt. % of the water-soluble polymer. Still more suitably, the catalyst composition comprises 0.5-5 wt. % of the water-soluble polymer. Yet more suitably, the catalyst composition comprises 0.5-4 wt. % of the water-soluble polymer. Most suitably, the catalyst composition comprises 0.5-3 wt. % of the water-soluble polymer.

In another embodiment, the catalyst composition comprises between 1.0-4.0 wt. % of the water-soluble polymer. Suitably, the catalyst composition comprises between 1.0-2.0 wt. % of the water-soluble polymer.

The Absorbent

The absorbent present in the catalyst composition of the present invention assists in the processing and formation of the catalyst compositions of the present invention by acting as a reservoir for moisture and/or water that is used during manufacture. The absorbent also assists in binding together the components of the catalyst composition, especially during the drying stages of manufacture.

Any suitable absorbent may be used. The absorbent is suitably a starch. Starches are glucose polymers in which glucopyranose units are bonded by alpha-linkages. Suitably, the absorbent is a starch selected from potato starch, maize starch, wheat starch, rice starch and partially pregellatinised starches from the aforementioned list. Alternatively, the absorbent may be a modified starch or a gum. Most suitably, the absorbent is maize starch or potato starch.

In an embodiment, the catalyst composition comprises 5-50 wt. % of the absorbent. In another embodiment, the catalyst composition comprises 15-50 wt. % of the absorbent. In another embodiment, the catalyst composition comprises 30-55 wt. % of the absorbent. In another embodiment, the catalyst composition comprises 35-50 wt. % of the absorbent. Suitably, the catalyst composition comprises 17.5-47.5 wt. % of the absorbent.

In another embodiment, the catalyst composition comprises 35-48 wt. % of the absorbent. Suitably, the catalyst composition comprises 40-48 wt. % of the absorbent. More suitably, the catalyst composition comprises 42-48 wt. % of the absorbent. Most suitably, the catalyst composition comprises 41-46 wt. % of the absorbent.

The Filler

The filler utilised in the catalyst compositions of the present invention may be an organic filler, an inorganic filler, or a mixture thereof.

In an embodiment, the filler comprises one or more organic fillers. Examples of suitable organic fillers include saccharides, polysaccharides, and derivatives thereof. As used herein, the term “saccharide” refers to the group that includes sugars, starch and cellulose. The saccharides are divided into the following chemical groups: monosaccharides, disaccharides, oligosaccharides and polysaccharides.

As used herein, the term “monosaccharide” refers to the simple sugars that are the building blocks of carbohydrates. A monosaccharide cannot be further reduced by hydrolysis into another simple sugar. Examples of monosaccharides include glucose, dextrose, fructose and galactose.

As used herein, the term “disaccharide” refers to a carbohydrate formed when two monosaccharides undergo a condensation reaction which involves the elimination of a small molecule, such as water. Examples of disaccharides include sucrose, lactose, and maltose.

As used herein, the term “oligosaccharide” refers to a carbohydrate formed from a small number (typically three to nine) of monosaccharide units.

As used herein, the term “polysaccharide” refers to polymeric carbohydrate molecules composed of long chains of monosaccharide units bound together by glycosidic linkages, which on hydrolysis give the constituent monosaccharides or oligosaccharides. Polysaccharides range in structure from linear to highly branched. The term “polysaccharide” typically refers to molecules containing ten or more monosaccharide units, although it may also encompass molecules with fewer than ten monosaccharide units. When all the monosaccharides in a polysaccharide are the same type, the polysaccharide is called a homopolysaccharide or homoglycan, but when more than one type of monosaccharide is present they are called heteropolysaccharides or heteroglycans. Polysaccharides have the general formula of Cₓ(H₂O)_{y} where x is typically a number between 200 and 2,500. As the repeating units in the polymer backbone are often six-carbon monosaccharides, the general formula can also be represented as (C₆H₁₀O₅)ₙ where 40≤n≤3000. Examples of suitable polysaccharides include starch, cellulose, glycogen, chitin, callose or laminarin, chrysolaminarin, xylan, arabinoxylan, mannan, fucoidan and galactomannan.

As used herein, the term “derivative” refers to a chemically or physically modified saccharide or polysaccharide, for example, carboxy methyl cellulose.

In a particular embodiment, the filler is an organic filler that is a cellulosic material. The cellulosic material may be cellulose fibres (including microcrystalline cellulose), methyl cellulose, hydroxyethyl cellulose, hydroxypropyl cellulose or carboxy-functional celluloses such as carboxymethyl cellulose. Most suitably, the cellulosic material is microcrystalline cellulose.

In another embodiment, the filler is an inorganic filler. Inorganic fillers include talcs, micas, zeolites, silicates and clays. Suitably, the inorganic filler is selected from talcs, micas, zeolites or silicates. More suitably, the inorganic filler is talc. In an embodiment, the filler is not bentonite.

In an embodiment, the filler is a cellulosic compound, optionally in combination with an inorganic filler selected from talcs, micas, zeolites, silicates and clays.

In an embodiment, the filler is a mixture of microcrystalline cellulose and talc.

In another embodiment, the filler is microcrystalline cellulose (e.g. Hewetten 101).

In an embodiment, the catalyst composition comprises 10-80 wt. % of the filler. In another embodiment, the catalyst composition comprises 5-50 wt. % of the filler. Suitably, the catalyst composition comprises 10-50 wt. % of the filler. More suitably, the catalyst composition comprises 15-50 wt. % of the filler. Even more suitably, the catalyst formulation comprises 25-50 wt. % of the filler. Even more suitably, the catalyst formulation comprises 35-50 wt. % of the filler. Most suitably, the catalyst formulation comprises 37.5-50 wt. % of the filler.

In another embodiment, the catalyst composition comprises 40-50 wt. % of the filler. More suitably, the catalyst composition comprises 42-48 wt. % of the filler. Most suitably, the catalyst composition comprises 44-48 wt. % of the filler.

The Water Soluble Salt

The water-soluble salt is suitably a salt that dissolves in water (e.g. at a concentration of 5 g/100 mL) to form an aqueous solution having a pH of 5 to 9.5 at 25° C. In contrast to strongly alkaline salts such as carbonates, the water soluble salts used in the compositions of the present invention do not have a detrimental effect on the washing process when they are used as part of a detergent formulation (or detergent formulation). Suitable examples of water soluble salts include alkali metal, alkali earth metal or transition metal salts of bicarbonates, halides, sulfates, phosphates, oxides, acetates, citrates or nitrates.

In certain embodiment, the water-soluble salt is one which forms an aqueous solution (e.g. a 0.1 N solution) having a pH of between 5.5 to 9, suitably having a pH of between 6.5 to 9 or, more suitably, having a pH of between 7 to 9, at 25° C.

In an embodiment, the water-soluble salt comprises one or more salts selected from the group consisting of sodium bicarbonate, sodium sulfate, sodium chloride, sodium acetate, potassium sulfate, potassium chloride and sodium citrate. Suitably, the water-soluble salt comprises one or more selected from the group consisting of sodium sulfate and sodium citrate.

In an embodiment, the catalyst composition comprises 0-30 wt. % of the water-soluble salt. In another embodiment, the catalyst composition comprises 0-25 wt. % of the water-soluble salt. In another embodiment, the catalyst composition comprises 3-20 wt. % of the water-soluble salt. In another embodiment, the catalyst composition comprises 3-15 wt. % of the water-soluble salt.

In another embodiment, the catalyst composition comprises 4-12 wt. % of the water-soluble salt. Suitably, the catalyst composition comprises 4-10 wt. % of the water-soluble salt. Most suitably, the catalyst composition comprises 4-8 wt. % of the water-soluble salt.

Particular Embodiments of the Catalyst Composition

Particular embodiments of the catalyst composition defined herein include any one of the following:

1. 1-7 wt. % of a bleach-activating catalyst;
0.5-15 wt. % of a water-soluble polymer;
5-50 wt. % of an absorbent;
10-80 wt. % of a filler; and
0-30 wt. % of a water-soluble salt;

2. 1-6 wt. % of a bleach-activating catalyst;
0.5-10 wt. % of a water-soluble polymer;
15-50 wt. % of an absorbent;
5-50 wt. % of a filler; and
0-25 wt. % of a water-soluble salt;

3. 1-5 wt. % of a bleach-activating catalyst;
0.5-8 wt. % of a water-soluble polymer;
30-55 wt. % of an absorbent;
10-50 wt. % of a filler; and
0-25 wt. % of a water-soluble salt;
4. 1-4 wt. % of a bleach-activating catalyst;
0.5-5 wt. % of a water-soluble polymer;
35-50 wt. % of an absorbent;
15-50 wt. % of a filler; and
3-20 wt. % of a water-soluble salt;

5. 2-5 wt. % of a bleach-activating catalyst;
0.5-4 wt. % of a water-soluble polymer;
35-50 wt. % of an absorbent;
25-50 wt. % of a filler; and
3-15 wt. % of a water-soluble salt;

6. 2-4 wt. % of a bleach-activating catalyst;
0.5-3 wt. % of a water-soluble polymer;
35-50 wt. % of an absorbent;
35-50 wt. % of a filler; and
3-15 wt. % of a water-soluble salt;

7. 2-4 wt. % of a bleach-activating catalyst;
0.5-3 wt. % of a water-soluble polymer;
40-48 wt. % of an absorbent;
40-50 wt. % of a filler; and
4-12 wt. % of a water-soluble salt;
8. 2-4 wt. % of a bleach-activating catalyst;
0.5-3 wt. % of a water-soluble polymer;
41-46 wt. % of an absorbent;
42-58 wt. % of a filler; and
4-8 wt. % of a water-soluble salt.

In any of numbered paragraphs (1) to (8) above, the bleach-activating catalyst, water-soluble polymer, absorbent, filler and water-soluble salt may have any of the definitions appearing hereinbefore.

Suitably, in any of numbered paragraphs (1) to (8) above, the bleach-activating catalyst comprises manganese. More suitably, in any of numbered paragraphs (1) to (8) above, the bleach-activating catalyst is selected from [Mn ^{Iv}₂ (μ-O)₃ (Me-TACN)₂ (PF₆)₂ or [Mn^{Iv}Mn^{III} (μ-O)₂ (μ-OAc) (Me₄4-DTNE)] (PF₆)₂.

Suitably, in any of numbered paragraphs (1) to (8) above, the water-soluble polymer is poly(vinyl alcohol) or a poly(vinyl alcohol)-based polymer. More suitably, in any of numbered paragraphs (1) to (8) above, the water-soluble polymer is a poly(vinyl alcohol)-based polymer in which a portion of the hydroxyl groups have been modified by reaction with a (2-10C)aldehyde (e.g. butyraldehyde).

Suitably, in any of numbered paragraphs (1) to (8) above, the absorbent is a starch. Suitably, the starch is potato starch or maize starch.

Suitably, in any of numbered paragraphs (1) to (8) above, the filler is selected from talc, a mica, a zeolite, a silicate, microcrystalline cellulose, or a mixture of microcrystalline cellulose and talc. More suitably, in any of numbered paragraphs (1) to (8) above, the filler is microcrystalline cellulose, or a mixture of microcrystalline cellulose and talc.

Suitably, in any of numbered paragraphs (1) to (8) above, the water-soluble salt is selected from sodium sulfate, sodium chloride, sodium acetate, potassium sulfate, potassium chloride and sodium citrate. Most suitably, in any of numbered paragraphs (1) to (8) above, the water-soluble salt is selected from sodium sulfate, sodium citrate, or a mixture thereof.

In an embodiment, the catalyst composition has a moisture content of 10 wt. % or less. Suitably, the catalyst composition has a moisture content of 8 wt. % or less. More suitably, the catalyst composition has a moisture content of 5 wt. % or less. Yet more suitably, the catalyst composition has a moisture content of 4 wt. % or less. Most suitably, the catalyst composition has a moisture content of 2 wt. % or less.

In another embodiment, the catalyst composition has a moisture content of between 0.1 wt. % and 10 wt %. Suitably, the catalyst composition has a moisture content of between 0.1 wt. % and 8 wt %. More suitably, the catalyst composition has a moisture content of between 0.1 wt. % and 5 wt %. Most suitably, the catalyst composition has a moisture content of between 0.5 wt. % and 4 wt %.

In another embodiment, the catalyst composition is organic solvent-free. Owing to the fact that the compositions of the invention are processed using aqueous solvent, they may be devoid of any organic solvent.

The catalyst composition is suitably provided in particulate or granular form (i.e. as particles or granules). Suitably, the particles or granules are matrix particles. It will be understood that within such a matrix particle, all of the components of the particle or granule may be substantially uniformly distributed throughout the entirety of the particle or granule, with the water soluble polymer (e.g. PVB) acting as a suitable binding agent.

In an embodiment, the solid catalyst formulation has an average particle size of 10 to 10,000 p.m. The particles can be substantially granular, spherical, or spheroidal, or cylindrical in shape. Where the particles are spherical, or spheroidal, suitable mean particle diameters are 10 to 3,000 μm, more suitably 100 to 2,000 μm. Where the particles are cylindrical in shape, they may have mean diameters of 100 to 2,000 μm. Suitably, the cylinders are 0.5 to 5 cm, or more typically 0.5 to 2 cm, in length.

In an embodiment, the catalyst composition is comprised of particles having a mean particle size of between 0.2 mm to 1.5 mm. Suitably, the catalyst composition is comprised of particles having a mean particle size of between 0.5 mm to 1.5 mm. The particles may be of any suitable form. Suitably, the particles are granular in form.

Additionally, the colour of the particles can be altered via the incorporation of a dye or pigment into the particle core or as part of the coating. Thus, in an embodiment, the catalyst composition comprises one or more colourants (e.g. one or more dye molecules and/or pigment molecules).

Preparation of the Catalyst Compositions

As described hereinbefore, the present invention also provides a process for the preparation of a catalyst composition as defined herein, said process comprising the steps of:
a) mixing the bleach-activating catalyst agent, water-soluble polymer, absorbent, filler, water-soluble salt, and water;
b) forming particles; and
c) drying the particles resulting from step b).

The catalyst compositions of the present invention may be formed by any suitable techniques known in the art.

In an embodiment, the quantity of water used in step a) of the process is such that the particles resulting from step b) are granular.

In another embodiment, step c) of the process comprises drying the particles resulting from step b) in a fluid bed dryer.

In yet another embodiment, step c) of the process comprises drying the particles resulting from step b) at a temperature of between 25-80° C. Suitably, step c) of the process comprises drying the particles resulting from step b) at a temperature of between 35-60° C. Most suitably, step c) of the process comprises drying the particles resulting from step b) at a temperature of between 45-55° C.

In a further embodiment, prior to mixing in step a), the catalyst is heated to a temperature of between 50-100° C.

In yet a further embodiment, the water-soluble polymer mixed in step a) of the process is provided as an aqueous solution. Suitably, the water-soluble polymer mixed in step a) of the process is provided as a 2 wt % to 30 wt % aqueous solution. More suitably, the water-soluble polymer mixed in step a) of the process is provided as a 2 wt % to 20 wt % aqueous solution. Most suitably, the water-soluble polymer mixed in step a) of the process is provided as a 2 wt % to 10 wt % aqueous solution. Also, the water-soluble polymer mixed in step a) of the process may be provided as a 15 wt % to 25 wt % aqueous solution (e.g. a 18 wt % to 22 wt % aqueous solution).

The bleach-activating catalyst, water-soluble polymer, absorbent, filler, and water-soluble salt may be mixed together in the required proportions and then formed into particles by, for example, compression, granulation (wet or dry granulation), spheronisation and extrusion techniques. Alternatively, the water-soluble polymer may be applied to pre-formed particles of the bleach-activating catalyst in the form of a coating by using any suitable coating technique known in the art.

Particular examples of suitable extrusion, spheronisation, granulation and coating techniques are described in the accompanying example section herein.

Thus, in a particular embodiment, the catalyst composition is produced by a granulation technique. In such embodiments, step a) comprises adding water to the bleach-activating catalyst, water-soluble polymer, absorbent, filler, and water-soluble salt under mixing, wherein the quantity of water added is sufficient to form discrete granules of the mixture; step b) comprises forming discrete particles or granules from the mixture of step a); and step c) comprises drying the discrete particles or granules resulting from step b) (e.g. in a fluid bed dryer).

In another particular embodiment, the catalyst composition is produced by an extrusion technique. In such embodiments, step a) comprises mixing the bleach-activating catalyst, water-soluble polymer, absorbent, filler, water-soluble salt and water, to form a mixed mass, which is then extruded as an extrudate; and step b) comprises treating the extrudate of step a) so as to form discrete particles or granules (e.g. spheronisation); and step c) comprises drying the discrete particles or granules resulting from step b). In an embodiment, step b) of the process may be skipped and the extrudate resulting from step a) may be directly dried.

In another particular embodiment, the catalyst composition is produced by a compaction technique. In such embodiments, step a) comprises mixing the bleach-activating catalyst, water-soluble polymer, absorbent, filler, water-soluble salt and water, to form a mixed mass, which is then compacted under pressure; and step b) comprises treating the compacted mixture of step a) so as to form discrete particles or granules (e.g. spheronisation); and step c) comprises drying the discrete particles or granules resulting from step b).

As described hereinbefore, the present invention also provides a catalyst composition obtained, directly obtained or obtainable by a process defined herein.

Applications

Detergent Formulations

As described hereinbefore, the present invention also provides a detergent formulation (e.g. a laundry and/or dishwash detergent formulation) comprising a catalyst composition as defined herein.

Suitably, the detergent formulation of the present invention is a solid or powder.

The catalyst composition of the invention can be readily incorporated into granular or powder detergent formulations, wherein they demonstrate excellent stability.

In an embodiment, the detergent formulation comprises 1-30 wt. % of the catalyst composition. Suitably, the detergent formulation comprises 1-25 wt. % of the catalyst composition. More suitably, the detergent formulation comprises 1-10 wt. % of the catalyst composition. Yet more suitably, the detergent formulation comprises 1-5 wt. % of the catalyst composition. Most suitably, the detergent formulation comprises 2-3 wt. % of the catalyst composition.

In another embodiment, the detergent formulation comprises 0.01-10 wt. % of the bleach-activating catalyst. Suitably, the detergent formulation comprises 0.01-5 wt. % of the bleach-activating catalyst. More suitably, e detergent formulation comprises 0.01-2 wt. % of the bleach-activating catalyst. Yet more suitably, the detergent formulation comprises 0.01-1 wt. % of the bleach-activating catalyst. Most suitably, the detergent formulation comprises 0.01-0.5 wt. % of the bleach-activating catalyst.

Detergent Formulations (Including Bleaching Agent)

In a further aspect, the present invention provides a detergent formulation (e.g. a dishwasher or laundry washing composition) comprising a catalyst composition as defined herein, a bleaching agent and optionally a bleach activator.

Suitable detergent formulations to which the catalyst composition of the present invention can be added are known in the art and include, for example, dishwasher tablet compositions and laundry powder and tablet compositions.

The amount of catalyst composition added to the detergent formulation will vary depending on the loading of the catalyst in the particles of the composition, the nature of the catalyst, the amount of catalyst required, the operating conditions that the detergent formulation will be exposed to during use, the nature of the bleaching agent and any bleach activator that is present.

The amount of the catalysts composition added will typically be an amount sufficient to give a final loading 0.01 to 1 wt. % of bleach-activating catalyst in the detergent composition. This will typically require the detergent formulation to comprise 1 to 25 wt. % of the catalyst composition. In an embodiment, the detergent formulation comprises 1 to 10 wt. % of the catalyst composition. In another embodiment, the detergent formulation comprises 1 to 5 wt. % of the catalyst composition. In another embodiment, the detergent formulation comprises 2 to 3 wt. % of the catalyst composition. In a further embodiment, the detergent formulation comprises 0.5 to 2 wt. % of the catalyst composition.

The Bleaching Agent

The bleaching agent in the detergent formulation of the present invention is a solid material capable of providing bleaching action by, for example, the evolution of hydrogen peroxide or another peroxy species. Suitable examples of bleaching agents include, but are not limited to, persalts of alkali or alkali earth metal salts, such as perborate or percarbonate, a particular example of which is sodium percarbonate which can be thought of as the crystallisation product of sodium carbonate and hydrogen peroxide (2Na₂CO₃.3H₂O₂). Thus, in one embodiment, the bleaching agent is sodium percarbonate (SPC).

Suitably, the detergent formulation will comprise between 5 to 20 wt. % of a bleaching agent. In the case of dishwasher formulations, the amount of bleaching agent in the detergent formulation will suitably be between 5 to 15 wt. %, and more suitably between 8 to 12 wt. %.

The Bleach Activator

The term “bleach activator” is a term of the art, and we be readily understood to be an agent which can react with a bleaching agent to give a further bleaching compound which can act at lower temperatures. Non-limiting examples of suitable bleach activators include tetraacetyl ethylene diamine (TAED); benzoylcaprolactam (BzCL); 4-nitrobenzoylcaprolactam;3-chlorobenzoylicaprolactam; benzoyloxybenzene-sulfonate (BOBS); nonanoyloxy-benzenesulfonate (NOBS); phenyl benzoate (PhBz); decanoyloxybenzenesulfonate (Cio-OBS); benzoylvalerolactam (BZVL); octanoyloxybenzenesulfonate (C8-OBS); perhydrolyzable esters; 4-[N-(nonaoyl) amino hexanoyloxy]-benzene sulfonate sodium salt (NACA-OBS);dodecanoyloxybenzenesulfonate (LOBS or C12-OBS); 10-undecenoyl-oxybenzenesulfonate (UDOBS or Cn-OBS with unsaturation in the 10 position); decanoyloxybenzoic acid (DOBA); (6—octanamidocaproyl)oxybenzenesulfonate; (6-nonanamidocaproyl) oxybenzenesulfonate; (6-decanamidocaproyl)oxybenzenesulfonate and mixtures thereof.

In an embodiment, the bleach activator is tetraacetyl ethylene diamine (TAED).

Suitably, the detergent formulation will comprise between 2.5 to 10 wt. % of the bleach activator. In the case of dishwasher formulations, the amount of bleach activator in the detergent formulation will suitably be 2.5 to 7.5 wt. %, and most suitably 4 to 6 wt. %.

In yet another aspect, the present invention provides a process of forming a detergent formulation as defined herein, the process comprising mixing the particle composition of the present invention with a formulation comprising a bleaching agent and optionally a bleach activator.

The desired amount of the catalyst composition of the present invention can be added to an existing detergent formulation to provide the bleach-activating catalyst component in a stable and protected form. The particulate form of the catalyst makes it easy to incorporate and mix with other components of the detergent formulation.

During use, the bleach-activating catalyst is released in close proximity to the bleaching agent and any bleach activator component that is present in order to provide an effective bleach action at low temperatures.

In yet another aspect, the present invention provides a detergent formulation prepared by any one of the methods defined herein.

### EXAMPLES

Components, Abbreviations and Suppliers

Arbocel UFC M8 Rettenmaier Corporation

Avicel pH 101—Rettenmaier Corporation

Bentonite—RS minerals

Butyraldeyde—Aldrich Chemical Company

Celite 263—Imerys

Halloysite—Applied Minerals

Hewetten 101—Rettenmaier Corporation

Maize starch—Roquette Corporation

MCC Sidley Industrial 10—Sidley Chemical Co. Ltd

Mn Me-TACN—WeylChem GMBH

Patent blue—Aldrich Chemical Company

Peractive FDOX—WeylChem GMBH

Pigment Blue—Aldrich Chemical Company

Potato starch—Roquette Corporation

Poval®—Kuraray Co LTD

PVPP XL USP36/EP8 JH Nanhang Life Sciences C

Sodium hydroxide—Aldrich Chemical Company

Sodium sulfate—Aldrich Chemical Company

Sulfuric acid—Aldrich Chemical Company

Talc—Aldrich Chemical Company

Titanium dioxide—Aldrich Chemical Company

Trisodium citrate—Mistral Chemical Company

xl-PVP—Luvicross—BASF GmbH

xl-PVP—Polyplasdone—Ashland Inc.

Mn^{Iv}Mn^{III} (μ-O)₂ (μ-OAc) (Me4-1,2-bis (4,7-dimethyl-1,4,7—trazacyclonon-1-yl)-ethane) (PF₆) was obtained commercially.

The standard test ADW formulation was IEC Standard dishwash detergent type D code 88104 from WFK.

Moisture contents were measured on an Adam PMB 202 moisture balance.

Butyration of poly(vinyl alcohol):

The following procedure outlines the preparation of butyrated PVOH (PVB) solution, the same procedure was used for both 4-98, 4-88 and 10-98 PVOH starting materials: Poval® 4-98 (ex Kuraray, 300 g) was added to deionised water (1.2 L) with stirring at room temperature and heated to 90° C., over the course of 1 hour, and stirred with heating for a further 2 hours after which an isotropic, straw coloured solution of pH ˜5-6 was achieved. The solution was then cooled to 60° C. and 2 M H₂SO₄ (20.1 mL, 0.04 mols) was added giving pH ˜2-3, butyraldehyde (19.27 g, 0.27 mols) was then added, over 20 minutes, the solution was stirred at 60° C. for a further 4 hours before cooling to room temperature and neutralising to pH 7 with 0.5 M NaOH solution (approximately 160 mL). The butyrated poly(vinyl alcohol) solution (PVB) had a total solids content of ca 20% w/w. This solution was further diluted, as required, by the addition of deionised water.

Extrusion/Spheronisation—Preparation of Formulation ES 3 (Table 1)

Formation of the wet mass was performed on a food grade Kenwood FPP220 Multipro Compact mixer, the extrusion was perfumed on a Caleva Variable Density Extruder with the 0.7 mm diameter hole die plate. The spheronisation was performed on a Caleva Multi Bowl Spheroniser 250 (MBS250). Drying of the particles was performed on an Aeromatic Fielder Strea 1.

Microcrystalline cellulose (Hewetten 101) (52.5 g), Potato starch (46.9 g) and sodium sulfate (5.59 g) were weighed directly into a blender and mixed together for 10 seconds on speed setting “2”. Mn Me-TACN (5.59 g) was added to the blender and mixed for a further 10 seconds.

PVB (22.58 g, 5% solution in water) was added with mixing at Kenwood speed “2”, then de mineralised water (70.45 g) was added until the mixture reached the correct consistency, this was determined by taking a portion of the mixture and compressing by hand, when the material held a shape that required pressure to break it apart and gave a ‘slide’ texture between thumb and forefinger the material was ready. Extrusion was carried at 50 rpm, through a 1 mm axial die plate (1 mm thick) and the resulting material dried in a STREA fluid bed dryer for 45 mins with a 50° C. inlet temperature. To give particles with a mean size distribution of 0.8mm and a moisture content of 1.45% weight/weight.

The spheroids were either used as is or further coated with a polymeric coating solution prepared by the addition of a polymer/salt coating prepared by the mixing of equal volumes of the PVB solution and the salt solution prior to spray coating. The final coat weight was determined gravimetrically.

Formulation examples ES1, ES2, ES4 and ES5 were prepared by a similar procedure.

TABLE 1
Extrusion/Spheronisation - all 1 mm spheroids (smaller ones not included here)

| | Ingredients % w/w | | | | | |
|---|---|---|---|---|---|---|
| | | | | | | Bleach- |
| | | | | | | activating |
| | Filler | | Water- | Water soluble | Total | catalyst and |
| Reference | (type) | Absorbent | soluble salt | polymer (dry) | water/* | level |
| ES 1 | Heweten | Potato | | PVB 10-98 | | Mn Me- |
| | 101 | starch | | (8% BuA) | | TACN |
| | 46 | 46 | n/a | 3 | 38 | 5 |
| ES 2 | Heweten | Potato | Sodium | PVB 10-98 | | Mn Me- |
| | 101 | starch | sulfate | (8% BuA) | | TACN |
| | 46 | 42 | 5 | 2 | 45 | 5 |
| ES 3 | Heweten | Potato | Sodium | PVB 10-98 | | Mn Me- |
| | 101 | starch | sulfate | (8% BuA) | | TACN |
| | 47 | 42 | 5 | 1 | 46 | 5 |
| ES 4 | Arbocel | Potato | Sodium | PVB 10-98 | | Mn Me- |
| | UFC M8 | starch | sulfate | (8% BuA) | | TACN |
| | 47 | 42 | 5 | 1 | 49 | 5 |
| ES 5 | Heweten | Potato | Sodium | PVB 10-98 | | Mn Me- |
| | 101 | starch | sulfate | (8% BuA) | | TACN |
| | 48 | 43 | 5 | 1 | 44 | 3 |

*Total water refers to the percentage of water in the particles obtained from the PVB solution and the addition of further water during the preparation. It is expressed as a percentage with respect to the total dry components.

Wet Granulation—Preparation of Formulation Example WG 9 (Table 2)

Small-scale granulations were performed on a food grade Kenwood FPP220 Multipro Compact mixer and subsequently dried on an Aeromatic Fielder Strea 1 fluid bed dryer.

Microcrystalline cellulose (Hewetten 101) (108 g), potato starch (97.2 g) and sodium sulfate (11.25 g) were weighed directly into a blender and mixed together for 10 seconds on speed setting “2”. Mn Me-TACN (6.75 g) was added to the blender and mixed for a further 10 seconds.

PVB (45 g, 5% solution) was added with mixing at speed “2”, and then demineralised water (100.5 g) was added until the mixture reached the correct consistency. This was determined to be the point where the material formed discrete particles which moved with a roping action in the bowl of the blender.

The resulting material was dried in a STREA fluid bed dryer for 45 mins with a 50° C. inlet temperature. To give particles with a mean size distribution of 0.8mm and a moisture content of 4.5% weight/weight.

Examples WG 1 to 8, 10 and 15 were prepared in an identical manner to WG9 described above. Examples WG 11 to 14 were prepared in an identical manner except that the pigments were added to the dry mix prior to granulation.

TABLE 2
Wet granulation

| | Ingredients % w/w | | | | | | |
|---|---|---|---|---|---|---|---|
| | | | | Water | | | Bleach- |
| | | | Water- | soluble | | | activating |
| | Filler | Absorbent | soluble | polymer | | Total | catalyst and |
| Reference | (type) | (type) | salt | (dry) | Colourant | water * | level |
| WG 1 | Heweten | Potato starch | Sodium | PVB 4-98 | n/a | | Mn Me- |
| | 101 | | sulfate | (8% BuA) | | | TACN |
| | 37.5 | 37.5 | 30 | 2 | | 42 | 3 |
| WG 2 | Heweten | Potato starch | Sodium | PVB 4-98 | n/a | | Mn Me- |
| | 101 | | sulfate | (8% BuA) | | | TACN |
| | 42.5 | 42.5 | 10 | 2 | | 46 | 3 |
| WG 3 | Heweten | Potato starch | Sodium | PVB 10- | n/a | | Mn Me- |
| | 101 | | sulfate | 98 (8% | | | TACN |
| | | | | BuA) | | | |
| | 46.5 | 41.7 | 4.9 | 4 | | 44 | 3 |
| WG 4 | Heweten | Potato starch | Sodium | PVB 10- | n/a | | Mn Me- |
| | 101 | | sulfate | 98 (8% | | | TACN |
| | | | | BuA) | | | |
| | 47 | 42 | 5 | 1 | | 46 | 5 |
| WG 5 | Heweten | Potato starch | Sodium | PVB 4-98 | n/a | | Mn Me- |
| | 101 | | sulfate | (8% BuA) | | | TACN |
| | 47 | 42 | 5 | 1 | | 42 | 5 |
| WG 6 | Heweten | Halloysite | Sodium | PVB 4-98 | n/a | | Mn Me- |
| | 101 | | sulfate | (8% BuA) | | | TACN |
| | 47.9 | 43.1 | 5 | 1 | | 40 | 3 |
| WG 7 | Heweten | Celite 263 | Sodium | PVB 4-98 | n/a | | Mn Me- |
| | 101 | | sulfate | (8% BuA) | | | TACN |
| | 47.9 | 43 | 5.2 | 1 | | 51 | 3 |
| WG 8 | Heweten | Bentonite | Sodium | PVB 4-98 | n/a | | Mn Me- |
| | 101 | | sulfate | (8% BuA) | | | TACN |
| | 47.9 | 43 | 5 | 1 | | 36 | 3 |
| WG 9 | Heweten | Potato starch | Sodium | PVB 10- | n/a | | Mn Me- |
| | 101 | | sulfate | 98 (8% | | | TACN |
| | | | | BuA) | | | |
| | 48 | 43 | 5 | 1 | | 43 | 3 |
| WG 10 | Heweten | Sodium | Sodium | PVB - 4- | n/a | | Mn Me- |
| | 101 | citrate | sulfate | 98 (8% | | | TACN |
| | | | | BuA) | | | |
| | 55 | 20 | 20 | 2 | | 44 | 3 |
| WG 11 | Heweten | Potato Starch | Sodium | PVB 4-88 | Pigment | | Mn Me- |
| | 101 | | sulfate | 8% BA | blue 15 | | TACN |
| | 47.7 | 43.1 | 6.1 | 1.1 | 0.044 | 43 | 2 |
| WG 12 | Heweten | Potato Starch | Sodium | PVB 4-88 | Patent blue | | Mn Me- |
| | 101 | | sulfate | 8% BA | | | TACN |
| | 47.7 | 43.1 | 6.2 | 1 | 0.22 | 43 | 2 |
| WG 13 | Heweten | Potato Starch | Sodium | PVB 4-88 | Patent blue | | Mn Me- |
| | 101 | | sulfate | 8% BA | | | TACN |
| | 47.9 | 43.0 | 6 | 1 | 0.044 | 43 | 2 |
| WG 14 | Heweten | Potato Starch | Sodium | PVB 4-88 | Pigment | | Mn Me- |
| | 101 | | sulfate | 8% BA | blue 15 | | TACN |
| | 47.83 | 43.12 | 6.05 | 1.00 | 0.22 | 43 | 2 |
| WG 15 | Hewetten | Maize Starch | Sodium | PVB 4-88 | n/a | | Mn Me- |
| | 101 | | sulfate | 8% BA | | | TACN |
| | 48.0 | 43.0 | 6.0 | 1.0 | | 43 | 2 |

n/a—not available

Compaction—Preparation of Examples C 1 to C 5 (Table 3)

Small-Scale Compaction (C 1)

Small-scale compaction was performed via mixing on a food grade Kenwood FPP220 Multipro Compact mixer followed by compaction in a stainless steel ADW tablet die using a Perkin Elmer hydraulic press and subsequent drying in a Laboratory drying oven.

Microcrystalline cellulose (Hewetten 101) (48 g), potato starch (43 g) and sodium sulfate (6 g) were weighed directly into a food grade Kenwood FPP220 Multipro Compact mixer and mixed together for 20 seconds on speed setting “2”. Mn Me-TACN (2 g) was added to the blender and mixed for a further 20 -30 seconds.

PVB (7.5 g, 20% solution) was added to the mixer with continued mixing at speed “2”, The material was then compacted using the hydraulic press at a pressure of 2 tonnes for 1 minute to form a single compacted block, this block was then broken into granules using a mortar and pestle and sieved to obtain the correct particle size.

The resulting material was dried in a laboratory oven for two hours at 50° C. to give particles with a mean size distribution of 0.8 mm and a moisture content of 2.5% weight/weight.

Example C 2 was Prepared in a Similar Manner.

Large Scale Compaction (C 3)

Large scale compaction was performed on a Lodige ploughshare (FM 50) mixer and an Alexanderwerk WP5ON/75 roller compactor and a fluid bed drier.

General procedure:

Mixing was carried out in two 10 kg batches. The dry components (Hewwtten 101 (480 g), Maize starch (430 g), sodium sulphate (60 g) and Me-Mn TACN (20 g) were mixed for 5 minutes in the mixer on a ‘fast’ speed setting. The speed was then decreased to ‘slow’ and the PVB (8% butyration, 20% solids, 50 g) was added whilst mixing over 3 minutes. The speed of the mixer was then increased to ‘fast’ for a further 5 minutes. The material was then ready for the compaction stage. The moisture content of the powder after mixing was 7.10%. The mixed powder was then loaded into the compactor hopper (i.e. an Alexanderwerk roller compactor) and the machine set at a pressure of 50 to 80 bar pressure through the rollers at a ‘medium speed’ setting. The compacted material was then broken-up by the compactor to give a uniform crumb which was then sieved through a 1.4 mm to 0.425 mm sieve stack. After break-up and sieving, the granules were dried on a fluid bed drier at 80° C. to achieve a moisture content of between 2 to 4% weight/weight.

Examples C 4 and C 5 were prepared in a similar manner

TABLE 3
Compaction

| | Ingredients % w/w | | | | | | |
|---|---|---|---|---|---|---|---|
| | | | | Water | | | Bleach- |
| | | | Water- | soluble | | | activating |
| | Filler | Absorbent | soluble | polymer | | Total | catalyst and |
| Reference | (type) | (type) | salt | (dry) | Colourant | water * | level |
| C 1 | Heweten | Potato | Sodium | PVB 4-98 | n/a | | Mn Me- |
| | 101 | starch | sulfate | (8% BuA) | | | TACN |
| | 48.0 | 43.0 | 6 | 1 | | 6 | 2 |
| C 2 | Heweten | Maize | Sodium | PVB 4-98 | n/a | | Mn Me- |
| | 101 | starch | sulfate | (8% BuA) | | | TACN |
| | 48.0 | 43.0 | 6 | 1 | | 6 | 2 |
| C 3 | Heweten | Maize | Sodium | PVB 4-88 | n/a | | Mn Me- |
| (Compacted @ | 101 | starch | sulfate | (8% BuA) | | | TACN |
| 50 bar) | | | | | | | |
| | 48 | 43 | 6 | 1 | | 5 | 2 |
| C 4 | Heweten | Maize | Sodium | PVB 4-88 | n/a | | Mn Me- |
| (Compacted @ | 101 | starch | sulfate | (8% BuA) | | | TACN |
| 100 bar) | | | | | | | |
| | 48 | 43 | 6 | 1 | | 5 | 2 |
| C 5 | Heweten | Maize | Sodium | PVB 4-88 | n/a | | Mn Me- |
| (Compacted @ | 101 | starch | sulfate | (8% BuA) | | | TACN |
| 100 bar) | | | | | | | |
| | 46 | 43 | 6 | 1 | | 5 | 4 |

n/a—not available

Spray Coating—Preparation of Example CS 1 (Table 4)

Spray coating was performed on a Glatt Mini Glatt 5 spray dryer fitted with a top spray configuration with a 0.5 mm nozzle attachment.

Mn Me-TACN containing spheroids—Mn Me-TACN (5%)

Preformed Mn Me-TACN (5%) containing spheroids (10 g) were placed into the bowl of a Glatt Microkit. The particles were fluidised at a pressure of 0.35 bar and an air temperature of 40° C. PVB (41.11 g, 5% solution) was sprayed with an atomising pressure of 0.4 bar and an average polymer flow rate of 0.42 g/min. After 90 mins the particles were dried at 40° C. in the fluidised air for ten minutes and the coating weight was determined to be 18% w/w by gravimetric analysis, the sample was then referred to as CS 1.

The other examples listed in table 4 were prepared in a similar manner

TABLE 4
Coated spheroids

| | Ingredients % w/w | | | | |
|---|---|---|---|---|---|
| | Filler | Absorbent | | Total | Bleach-activating catalyst and |
| Reference | (type) | (type) | Coating | water * | level |
| CS 1 | Avicel pH | x1-PVP | PVB (10-98, 8% | | Mn Me-TACN |
| | 101 | Luvicross | BA) in 0.08M | | |
| | | | Na₂SO₄ | | |
| | 75.2 | 5.34 | 18 | 56 | 4.24 |
| CS 2 | Avicel pH | PVPP | PVB (10-98, 8% | | Mn Me-TACN |
| | 101 | 3 gb XL | BA) in 0.08M | | |
| | | USP36/EP8 | Na₂SO₄ | | |
| | 78 | 5.4 | 11 | 53.2 | 5.4 |
| CS 3 | Heweten | Polyplasdone | PVB (10-98, 8% | | Mn Me-TACN |
| | 101 | xl-PVP | BA) in 0.08M | | |
| | | | Na₂SO₄ + | | |
| | | | TiO₂ 3% w/w | | |
| | 78 | 5.4 | 18.9 | 55.25 | 5 |

Evaluation of Formulations

Screening Equipment

Dishwasher—Hoover Dynamic 3D

Tumble dryer—Hoover infinity VHC 68B

Spectrophotometer—Data Colour International portable unit with a D65 light source

Tablet press—Perkin Elmer Manual 15Ton Hydraulic Press

Standard tea-stained cloths—EMPA 167 cloths

Dishwash formulation—WFK IEC Standard dishwash detergent type D code 88104

Testing Conditions

19.80g of standard ADW detergent was weighed out, to this was added 0.2 g of a 5% w/w catalyst containing composite. The materials were mixed together using a spatula and pressed into a stainless steel ADW tablet die using 5 tonnes of pressure for 60 seconds. The tablet was then used immediately for testing or placed into an open bag in an incubator at 30° C. and 80% relative humidity for storage testing over 7 or 14 days. A square standard tea-stained cloth ˜16 cm² (6 g) was used for each experiment, L*a*b* and reflectance at 460 & 700 nm measurements were taken prior to the wash and each cloth was measured four times at different positions to give an average reading. The cloth was then suspended from the middle shelf of the dishwasher with clips and the correct wash cycle selected. A standard, light load, of white crockery was placed in the machine with each test. Two wash cycles were used for testing, “P2 Daily”—a fast cycle for mixed, lightly soiled loads of crockery, glassware, cutlery, pots and pans (55° C. 1 hour 20 mins, referred to herein as the “long wash” or “LW”) and “P4 rapid”—a very short cycle (50° C. 29 mins, referred to herein as the “short wash” or “SW”).

After the wash, the cloth was dried in the tumble dryer for 20 mins on the “extra dry” setting and allowed to cool to room temperature before being re-measured using the spectrophotometer. The difference in the 460 nm reflectance value of the cloth before and after the wash was recorded and the reflectance value of a control sample with no catalyst was subtracted, that is the reflectance values were normalised to give the Mn Me-TACN value at time zero 100%, with each relative reduction in this value being quoted as a % decrease. This number was then used as a measure of catalyst performance and relative stability.

Screening Results

| Composition | | 7 Days/% | 14 days/% |
|---|---|---|---|
| Mn Me-TACN untreated | SW | 39 | 18 |
| (commercially available) | LW | 37 | 39 |
| ES 2 | SW | 80 | 77 |
| ES 5 | SW | 59 | 22 |
| WG 2 | SW | 80 | 44 |
| WG 3 | SW | 68 | 58 |
| WG 4 | SW | 58 | 38 |
| WG 6 | SW | 35 | 51 |
| WG 7 | SW | 49 | 24 |
| WG 8 | SW | 23 | 2 |
| WG 9 | SW | 75 | 31 |
| | LW | 77 | 49 |
| WG 10 | SW | 60 | 45 |
| C 1 | LW | 62 | 45 |
| C 2 | LW | 69 | n/a |
| C 3 | LW | 83 | 61 |
| C 4 | LW | 83 | 78 |

n/a—not available
SW = short wash cycle
LW = long wash cycle

While specific embodiments of the invention have been described herein for the purpose of reference and illustration, various modifications will be apparent to a person skilled in the art without departing from the scope of the invention as defined by the appended claims.

1. A catalyst composition comprising a plurality of particles, wherein said particles comprise:
0.1-8 wt. % of a bleach-activating catalyst;
0.1-20 wt. % of a water-soluble polymer;
5-55 wt. % of an absorbent;
5-85 wt. % of a filler; and
0-40 wt. % of a water-soluble salt;
with the proviso that the particles do not comprise more than 10 wt. % of a bleach activator.

2. A catalyst composition according to claim 1, wherein the particles do not comprise more than 1 wt. % of a bleach activator.

3. A catalyst composition according to claim 1, wherein the particles do not comprise a bleach activator.

4. A catalyst composition according to claim 1, wherein the water-soluble polymer is poly(vinyl alcohol) or a poly(vinyl alcohol)-based polymer.

5. A catalyst composition according to claim 1, wherein the water-soluble polymer is a poly(vinyl alcohol)-based polymer in which a portion of the hydroxyl groups have been modified by reaction with a (2-10C)aldehyde.

6. (canceled)

7. (canceled)

8. A catalyst composition according to claim 1, wherein the catalyst composition comprises 0.5-20 wt. % of the water-soluble polymer.

9. (canceled)

10. (canceled)

11. (canceled)

12. (canceled)

13. (canceled)

14. A catalyst composition according to claim 1, wherein the bleach activating catalyst is selected from transition metal-based salts or complexes comprising one or more metals selected from iron, cobalt, manganese, vanadium, ruthenium, titanium, copper or molybdenum.

15. (canceled)

16. A catalyst composition according to claim 1, wherein the bleach-activating catalyst is [Mn^{Iv}₂ (μ-O)₃ (Me-TACN)₂ (PF₆)₂ and/or [Mn^{Iv}Me^{III} (μ-O)₂ (μ-OAc) (Me₄ 4-DTNE)] (PF₆)₂.

17. A catalyst composition according to claim 1, wherein the bleach- activating catalyst is manganese bis(N,N′, N″-trimethyl-1,4,7-triazacyclononane)-trioxo-dimanganese (IV) di(hexafluorophosphate).

18. (canceled)

19. (canceled)

20. A catalyst composition according to claim 1, wherein the bleach-activating catalyst is present in an amount of 1.5 to 3 wt. % of the catalyst composition.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (cancelled)

34. (canceled)

35. (canceled)

36. (canceled)

37. (canceled)

38. A catalyst composition according to claim 1, wherein the composition comprises 35-50 wt. % of the absorbent.

39. (canceled)

40. (canceled)

41. A catalyst composition according to claim 1, wherein the water-soluble salt dissolves in water to form a solution having a pH of 5 to 9.

42. (canceled)

43. (canceled)

44. A catalyst composition according to claim 1, wherein the composition comprises 3-30 wt. % of the water-soluble salt.

45. (canceled)

46. (canceled)

47. (canceled)

48. (canceled)

49. (canceled)

50. (canceled)

51. (canceled)

52. (canceled)

53. (canceled)

54. A catalyst composition according to claim 1, wherein the catalyst composition is uncoated.

55. A detergent formulation comprising a catalyst composition as defined in claim 1.

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)
